(19) United States
(12) Patent Application Publication
(10) Pub. No.: US 2022/0013845 A1
(43) Pub. Date: Jan. 13, 2022

(54) LID FOR A BATTERY MODULE, BATTERY MODULE ARRANGEMENT AND BATTERY

(71) Applicant: Webasto SE, Stockdorf (DE)

(72) Inventors: Jochen Haussmann, Stockdorf (DE); Mario Meyer, Stockdorf (DE); Dirk Scheid, Stockdorf (DE)

(21) Appl. No.: 17/293,815

(22) PCT Filed: Nov. 14, 2019
(86) PCT No.: PCT/EP2019/081279

§ 371 Date: May 13, 2021

(30) Foreign Application Priority Data
Nov. 14, 2018 (DE) 20 2018 106 448.7

(51) Int. Cl. H01M 50/271; H01M 50/209; H01M 50/296; H01M 50/249; B60L 50/64

(52) U.S. Cl. CPC H01M 50/271; H01M 50/209; H01M 2220/20; H01M 50/249; B60L 50/64; H01M 50/296

(57) ABSTRACT

The present invention relates to a lid for a battery module, in particular in an electric vehicle, comprising a cover section for pole-side attachment of the lid to the battery module, and tabs which are provided at opposite ends of the cover section, are arranged inclined relative to the cover section and, in a state in which the lid is installed on the battery module, extend from the cover section in a direction pointing away from the battery module.

### CROSS-REFERENCE TO RELATED APPLICATIONS

This application is a 35 U.S.C § 371 National Stage Entry of International Application No. PCT/EP2019/081279 filed Nov. 14, 2019, which claims the priority benefit of German Patent Application Serial Number DE 202018106448 filed Nov. 14, 2018, all of which are incorporated herein by reference in their entirety for all purposes.

### TECHNICAL FIELD

The present invention relates to a lid for a battery module, to a battery module arrangement with such a lid and to a battery with at least two battery module arrangements for an electric vehicle.

### BACKGROUND

An electric vehicle is understood here to be an electrically driven vehicle, in particular a purely electrically driven vehicle or a hybrid vehicle. Such vehicles are equipped with an electric energy storage in the form of a battery, for example a traction battery or drive battery which stores electrical energy which is necessary for the driving mode and makes it available. The batteries are also referred to as accumulators. These are generally electrochemical accumulators, in particular lithium-ion accumulators.

Such batteries are usually not constructed as a monobloc but rather in a modular fashion from a multiplicity of battery cells which are connected to one another electrically. In order to construct a battery system in an electric vehicle it is correspondingly known to arrange battery cells in battery modules and to combine them to form a battery. This increases the configurability of battery systems and permits the use of comparatively cost-effective standard battery cells. Such battery systems can also comprise a housing which accommodates the battery modules, electrical circuits and a battery management system.

According to the present disclosure a battery cell is understood to be an electrochemical storage cell, preferably a secondary cell. The term “cell” can be understood in terms of the physical appearance of the component as a smallest structural unit with which contact can be made. In contrast, a battery module is understood to be a structural unit which comprises a multiplicity of battery cells. A battery or battery system is correspondingly understood to be a structural unit which is constructed from one or more battery modules which are connected together. The battery or the battery system is preferably provided for use in an electric vehicle, but can also be used in other vehicles or other fields of application.

The prior art has disclosed battery modules for use in an electric vehicle, in which modules a plurality of battery cells which are connected together are arranged in a receptacle container or housing and are covered on the pole side by means of a plate-shaped lid made of plastic. Such lids are usually of planar design and are provided with two cutouts for the poles of the battery cells.

### SUMMARY OF THE INVENTION

Taking the known prior art as a starting point for an object addressed by the present invention is to propose an improved lid for a battery module in an electric vehicle. Furthermore, a battery module arrangement and a battery with such a lid are to be provided.

This is achieved by means of a lid for a battery module having the features of claim 1, a battery module arrangement having the features of claim 12 and a battery having the features of claim 13. Advantageous developments emerge from the dependent claims.

Correspondingly, a lid for a battery module is proposed, comprising a cover section for pole-side attachment of the lid to the battery module and tabs which are provided at opposite ends of the cover section and are arranged inclined relative to the cover section. In a state in which the lid is installed on the battery module, the tabs extend from the cover section in a direction pointing away from the battery module.

In the solution proposed here, the tabs which are provided at ends, lying opposite one another, of the cover section, permit the lid to have a higher functionality than the arrangements known from the prior art, so that they can contribute to an improved refinement of a battery which comprises the battery module.

Specifically by virtue of the fact that the tabs are arranged at ends, lying opposite one another, and are inclined with respect to the cover section, the proposed lid fulfills the function of a mechanical protective component which protects the battery module, attached thereto, against excessively high bending torques and torsional torques. To be more precise, this is achieved by virtue of the fact that the proposed configuration of the tabs brings about an increase in the geometrical moment of inertia in the cross section of the lid, and the lid therefore has increased mechanical strength, in particular in comparison with bending loads and torsional loads acting on the lid and on the battery module. This can lead to increased operational reliability and improved protection of the battery module.

Furthermore in this way other components which ensure the mechanical strength and stability of the battery can be scaled smaller in the battery or at least partially dispensed with. Correspondingly, the proposed lid can contribute to a weight-optimized and force-flux-optimized configuration of the battery which comprises the battery module.

Alternatively or additionally, the tabs can each form a flange and serve to secure the battery module mechanically coupled thereto, within a battery, and to hold it there. The term “flange” is understood here to mean a connecting element which is configured to mechanically connect the lid to a battery component which bears against the flange. In this context, the flange can be provided to position the battery module which is connected to the lid relative to the battery component which is to be connected to the flange and to transmit operational forces between them. In other words, the proposed lid can form a mount for the battery module within a battery. For example, the flange can be configured to attach the battery module, which is mechanically coupled to the lid, to a carrier structure of a battery, for example to a housing of the battery.

Alternatively or additionally, the flange can be configured to attach the lid together with the battery module coupled mechanically thereto to a further lid of an adjacent battery module. In other words, in this way a plurality of battery modules can be connected to one another, wherein in such a battery system the respective lids form a supporting structure within the battery.

The flange can either be formed directly in the tab or can comprise an area of the tab which is formed bent once more with respect to the orientation of the tab. For example, the flange can comprise an upper area of the tab which is bent once more at a right angle to the outside. In the operating position of the battery module, the flange then extends horizontally so that a connection to an adjacently arranged battery module, for example the same type or for the purpose of connecting to a further battery component can be made by inserting a connecting means in a vertical direction.

In order to attach the flange formed by a tab to a battery component which adjoins it or an adjacent battery module, different joining methods can be used. For example the flange can be configured to be connected to an adjoining battery component by means of pressing, for example using screws, or by means of joining by shaping, for example using rivets.

The individual housing parts, in particular the connection of the lid to further housing parts of the battery module, can also be connected to one another by means of different joining methods. For example, the housing parts can be connected to one another by means of pressing, for example using screws, or by means of joining by shaping, for example by means of rivets and in particular by means of semi-tubular punch rivets.

Correspondingly this way the tabs can fulfil the function of securing and/or holding the battery module within a battery, in particular a battery housing. With this configuration it is also possible for the lid therefore to fulfil further functions in comparison with configurations which are known from the prior art, so that it is correspondingly possible to at least partially dispense with other components which fulfil this function, as a result of which the configuration of the battery which comprises the battery module can be optimized further.

Alternatively or additionally, the tabs can also fulfil the function of a mounting aid for simplified handling of the battery modules when mounting or servicing batteries. For example, the tabs can provide mechanical gripping facility for more easily lifting up and moving the battery module. More precisely, the tabs can be configured to move, with a mounting tool, into mechanical engagement, in particular into positively locking engagement, in a detachable fashion. Alternatively or additionally, the tabs can form or comprise a grip for a fitter. For example, the tabs can have at least one connecting element which is complementary to the mounting tool and which is configured to mechanically connect the lid to the mounting tool in a detachable fashion. For example, the connecting element can be placed in positive locking engagement with a connecting element, complementary thereto, of the mounting tool, in order to connect the lid mechanically to the mounting tool. In this way, the handling of the lid can be simplified with or without the battery module which is mechanically coupled thereto, and correspondingly mounting or removal of the battery for a fitter can be simplified.

For example, the connecting element which is provided on the tabs can be provided in the form of a through-opening which passes through the tabs, for example in the form of a drilled through-hole or an elongate hole or a punched-out portion or a polygonal formed opening, for example in the form of a rectangular or square or polygonal punched-out portion which can be moved into positively locking engagement with a connecting element which is complementary thereto, for example in the form of a connecting pin, embodied in a complementary fashion to the form of the grilled through-opening, of the fitting tool. In one embodiment, the fitting tool can be provided in the form of a handle for the fitter, which handle is provided at a coupling point to the connecting pin, wherein the connecting pin can be introduced into the through-opening which is provided on the tab, in order to connect the handle in a positively locking fashion to the lid and therefore simplify handling of the battery module for the fitter. Alternatively, the tabs can be provided with a connecting pin, and the fitting tool can be provided with an opening which is complementary thereto.

As described above, the tabs are arranged in such a way that in the state in which the lid is installed on the battery module they extend from the cover section in a direction pointing away from the battery module. The tabs can project here from a first surface of the cover section, which surface points away, or is turned away, from the battery module in the state in which the cover is installed on the battery module. The first surface is preferably arranged opposite a second surface of the cover section and in the mounted state of the cover said surface bears against the battery module or lies opposite it. In other words, in the mounted state of the cover the tabs start from the cover section and point away from a plane which is spanned by a contact face between the lid and the battery module. This arrangement of the tabs ensures that the tabs are easily accessible even in the state in which the lid is attached to the battery module.

Furthermore, the proposed arrangement of the tabs permits reliable processing in terms of the positioning and securing of further battery components to at least one tab, such as for example cables or cable harnesses. For this purpose, at least one connecting point for a connecting element can be provided, for example in the form of an edge clip, on at least one tab. The connecting point can be provided, for example, in the form of at least one recess on the at least one tab.

The lid described here can be provided for use in batteries for electric vehicles, but is not limited to this application. Instead, the lid can also be used in batteries of other vehicles or in batteries for other areas of application.

For example, the lid is produced at least in certain sections from an insulating material, for example from a plastic. The tabs and the cover section of the lid are preferably of rigid design. In addition, the tabs and/or the cover section can be formed from a plate-shaped material.

The lid can be produced, in particular, by shaping, for example by bending, a plate-shaped component. For this purpose, opposite ends of the plate-shaped component can be bent over, wherein the bent-over ends of the plate-shaped component form the tabs, and the part of the plate-shaped component arranged between them form the cover section of the lid. Alternatively or additionally, the lid can be produced by casting, for example by injection molding.

The tabs of the lid can extend along a longitudinal side of the lid and/or of the battery module. The “longitudinal side” of the lid or of the battery module is understood to be here the longest side of the lid or of the battery module. Correspondingly, a longitudinal direction of the lid or of the battery module is understood to be a direction along which the longitudinal side extends. In particular, the tabs can extend along at least 50%, that is to say along at least half of the length of the longitudinal side, for example along 60%, 70%, 80%, 90% or 100% of the length of the longitudinal side. This configuration ensures high mechanical stability and strength of the lid, in particular with regard to bending torques and torsion torques. The tabs can also extend along a length along the longitudinal side of the lid which is less than 50% of the length of the longitudinal side, for example along 20% of the length of the longitudinal side.

The lid can be formed in such a way that in the state in which the lid is mounted on the battery module the tabs project over the battery module along a transverse direction of the lid and/or of the battery module on at least one side. A “transverse direction” is understood here to be a direction which is transverse to the longitudinal direction of the lid or of the battery module. For example, the lid can be embodied in such a way that the tabs each project over the battery module along the transverse direction on sides lying opposite one another. Correspondingly, in the mounted state a width of the lid along the transverse direction can be greater than a width of the battery module. Alternatively, the width of the lid can correspond substantially to the width of the battery module, or can be less than it.

Areas of the tabs can additionally also be bent outward so as to form a flange, in order to simplify a connection with a further battery module arranged next to it or another battery component. In particular, in this way a connection between two battery modules which are arranged one next to the other can be simplified by inserting a connecting means from above for example by inserting a bolt or a screw from above. This can simplify the mounting.

Alternatively or additionally, the tabs of the lid can extend along a transverse side of the lid and/or of the battery module. The “transverse side” of the lid or of the battery module is understood here to be a side which runs transverse to with respect to its longitudinal side. The transverse side extends correspondingly along the transverse direction of the lid and/or of the battery module. The longitudinal side and transverse side of the lid preferably each coincide with the longitudinal side and transverse side of the battery module.

As described above, the tabs are arranged inclined relative to the cover section. To be more precise, the tabs are inclined substantially about 90° relative to the cover section. The tabs can also be inclined for an angle which is greater than or equal to 90° relative to the cover section.

The lid can have substantially a U-shaped profile view in cross section, wherein the cover section can form a web, and the tabs adjoining it can form the limbs of the U-shaped profile. In this context, in the mounted state on the battery module the outer side of the web of the U-shaped profile can bear on the battery module or lie opposite it.

The limbs of the profile which are formed by the tabs can be inclined or bent further at their ends relative to the cover section, in order, for example, to form a lid with a C-shaped profile. This can further improve the mechanical strength and rigidity of the lid, in particular with respect to bending loads and torsional loads. In the case of a C-shaped profile the ends of the tabs can be inclined or bent, for example about 90°, relative to a section of the tabs adjoining the cover section, and in this way can run in particular parallel to the cover section. In this context, the cover section correspondingly forms a web, and the tabs form the limbs of the C-shaped profile. The ends of the tabs can also be inclined or bent by more than 90° relative to the section of the tabs which adjoins the ends.

The cover section of the lid is configured for pole-side attachment to the battery module. In other words, the lid is configured to be attached to that side of the battery module on which its poles are arranged. As already described, the poles of the battery module are usually arranged on a common side of the battery module. The cover section can correspondingly be provided to cover that side of the battery module which has the poles. The battery module can have two or more than two poles. The shape of the cover section can be adapted to the shape of that side of the battery module which has the poles. Correspondingly, the cover section can have a shape which is complementary to the battery module. For example, the cover section can be embodied in a plate shape and can have, in particular, a planar or curved shape.

In one development, the cover section can comprise at least one positively engaging element which is complementary to a structure of the battery module, in particular in the form of a cutout for positioning the lid relative to the battery module and/or for connecting the lid to the battery module in a positively engaging fashion. For example, the cover section can have at least two cutouts for the poles of the battery module, wherein in the state of the lid in which the pole is mounted on the battery module the poles can be arranged in the cutouts and/or can project through the cutouts. In this context, the cutouts can form the positively engaging elements of the cover section. Correspondingly, the shape of the cutouts can be complementary to the shape of the poles or complementary to a structure of the battery module which is arranged around the poles. In particular, the cutouts can be configured to enter into engagement in a positively engaging fashion with the battery module, in particular with the poles or the structure of the battery module which is arranged around the poles. The structure which is arranged around the poles can be, for example, a connecting element in order to connect the poles in an electrically conductive fashion to an electrical conductor, for example a high-voltage cable.

The shape of the cutouts can be a non-rotationally symmetrical shape. It is therefore possible for a torque which acts along a longitudinal axis of the poles and/or of the cutouts to be transmitted between the lid and the poles or between the lid and the structure which is arranged around the poles. For example, the cutouts can be in the shape of a polygon, in particular of a hexagon.

In addition, a battery module arrangement is proposed, in particular for an electric vehicle, which comprises a battery module and a lid which is described above, wherein the lid is attached on a pole side to the battery module.

Since the proposed battery module arrangement comprises the lid specified above, the features described in relation to the lid are correspondingly considered to be disclosed for the proposed battery module arrangement.

In addition, a battery is proposed, in particular for an electric vehicle, comprising at least two battery module arrangements of the configuration which is described above and which are connected to one another via tabs, lying opposite one another, of the lids of the battery module arrangements.

Since the proposed battery comprises at least two of the battery module arrangements which are specified above, the features which are described above in relation to the battery module arrangement and the lid are considered to be correspondingly disclosed for the proposed battery.

In the proposed battery, the tabs, lying opposite one another, of the different lids bear one on the other and are connected to one another in a frictionally engaging and/or materially joined fashion, in particular by means of semi-tubular punch rivets. Alternatively or additionally, at least one tab of the lid of the battery module arrangements can be connected to a carrier structure of the battery, for example a housing of the battery, in a frictionally engaging and/or materially joined fashion, for example by means of rivets or semi-tubular punch rivets.

### BRIEF DESCRIPTION OF THE FIGURES

Preferred further embodiments of the invention are explained in more detail by means of the following description of the figures. In the figures, in each case in a schematic fashion:

FIG. 1 shows a battery module arrangement with a battery module and a lid which is attached thereto on the pole side,

FIG. 2 shows the lid, shown in FIG. 1, in a state which is detached from the battery module; and

FIG. 3 shows two battery module arrangements which are connected to one another.

### DETAILED DESCRIPTION OF PREFERRED EXEMPLARY EMBODIMENTS

In the text which follows, preferred exemplary embodiments are described with reference to the figures. In this context, identical, similar or identically acting elements are provided with identical reference numbers in the different figures, and to a certain extent a repeated description of these elements is dispensed with in order to avoid redundancy.

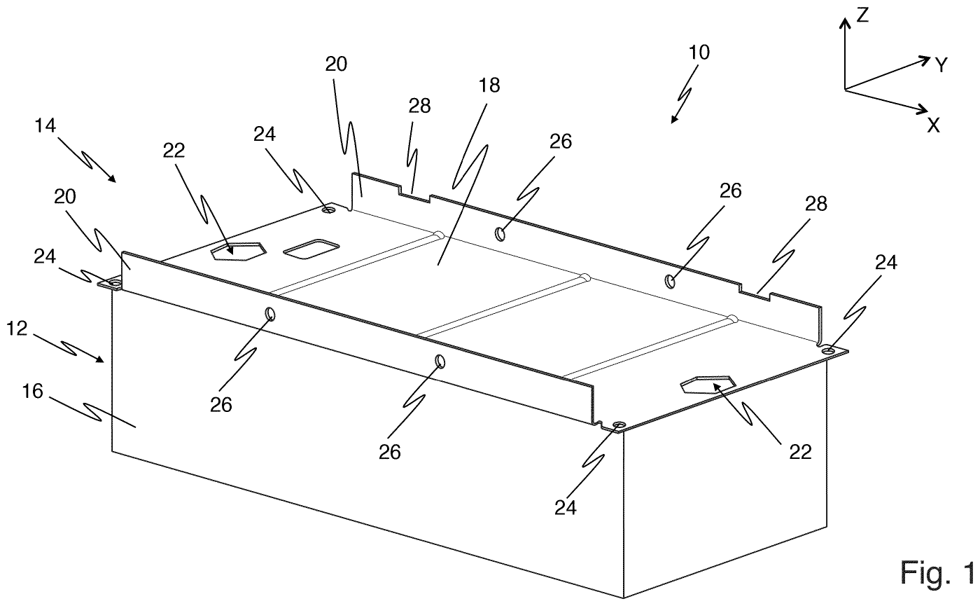

FIG. 1 shows a battery module arrangement 10 for use in a battery of an electric vehicle. The battery module arrangement 10 comprises a battery module 12 and a lid 14 which is attached thereto on the pole side. The battery module 12 comprises a plurality of interconnected battery cells which can be connected in an electrically conductive fashion to a consumer via poles which are not shown here. The battery cells are arranged in a battery module housing 16 which the lid 14 covers on the pole side.

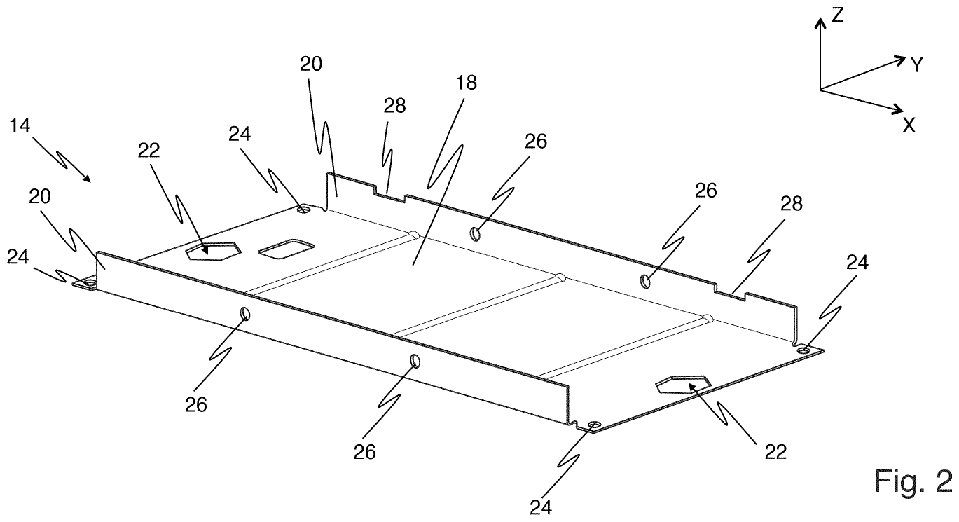

FIG. 2 shows the lid 14 for the battery module 12 in a state in which it is released from the battery module 12. The lid 14 comprises a cover section 18 for the pole-side attachment of the lid 14 to the battery module 12, and tabs 20 which are provided at opposite ends of the cover section 18, arranged inclined relative to the cover section 18, and in the state in which the lid 14 is installed on the battery module 12 they extend from the cover section 18 in a direction pointing away from the battery module 12.

The lid 12 is produced from an electrically insulating material, for example from a plastic. The tabs 20 extend along a longitudinal side and along a longitudinal direction X of the lid 14 and of the battery module 12. To be more precise, the tabs extend along substantially 90% of the length of the longitudinal side of the lid 14 and of the battery module 12. The lid 14 extends along a transverse direction Y of the lid 14 and of the battery module 12, which is perpendicular to the longitudinal direction X and a vertical direction Z, such that the tabs 20 project over the battery module 12 along the transverse direction Y on opposite sides of the lid 14. Correspondingly, a width of the lid 14 along the transverse direction Y is greater than a width of the battery module 12. Alternatively, the width of the lid 14 can substantially correspond to the width of the battery module 12 or be smaller than it.

The tabs 20 are inclined, in particular bent, about 90° relative to the cover section 18. Correspondingly, the lid 14 has a U-shaped profile in cross section, wherein the cover section 14 form a web, and the adjoining tabs 20 form limbs of the U-shaped profile, and wherein in the state in which the lid 14 is mounted on the battery module 12 the outer side of the web of the U-shaped profile bears against the battery module 12.

The cover section 18 comprises two positively engaging elements in the form of cutouts 22 which are complementary to a structure of the battery module 12 and have the purpose of positioning the lid 14 relative to the battery module 12 and of connecting the lid 14 in a positively engaging fashion to the battery module 12. To be more precise, the cutouts 22 are embodied in such a way that in the state in which the lid 14 is mounted on the battery module 12 they are positioned in these connecting elements (respectively not shown here) for connecting the poles of the battery module 12 in an electrically conductive fashion to a high voltage cable. The shape of the cutouts 22 is made complementary to an outer contour of the connecting elements. In this way, in a mounted state in the battery module 12 the connecting elements are in positively locking engagement with the lid 14. To be more precise, the cutouts 22 have a cross section in the form of a regular hexagon.

The cover section 18 is embodied in the form of a plate and has a shape which is complementary to that side of the battery module 12 which has the poles. In the region of its corners, the plate-shaped cover section 18 is provided with four first drilled through-holes 24 into which screws or other connecting means can be introduced in order to connect the lid 14 in a frictionally engaging fashion to the battery module 12.

Instead of the drilled through-holes 24 which are present with a round cross section, through-openings which are shaped differently can also be provided, said through-openings being able to be embodied, for example, as an elongate hole or as punched-out portion or as a polygonally formed opening, for example in the form of a rectangular or square or polygonal punched-out portion.

As is shown by FIGS. 1 and 2, the tabs 20 are provided with in each case two second drilled through-holes 26 which provide a mechanical gripping facility for more easily lifting up and moving the battery module arrangement 10. To be more precise, the second drilled through-holes 26 are configured to move into positively locking engagement with a mounting tool, in order to connect the mounting tool in a detachable fashion to the battery module arrangement 10. In other words, the second drilled through-holes 26 form connecting elements which are complementary to the mounting tool and are configured to mechanically connect the lid 14 in a detachable fashion to the mounting tool.

In addition, one of two tabs 20 of the lid 14 is provided with two recesses 28 at its upper ends, said recesses each forming a connecting point for a connecting element in the form of an edge clip, in order to secure cables or cable harnesses reliably in terms of process to the lid 14.

In the embodiment shown here, the tabs 20 each form a flange for attaching the lid 14 onto a carrier structure of a battery and/or to a further lid 14 of a further battery module 12. In other words, the tabs 20, embodied as a flange, of the lid 14 serve to secure and hold the battery module 12, coupled to the lid 14, within the battery. Correspondingly, the lid 14 forms part of a supporting structure within the battery.

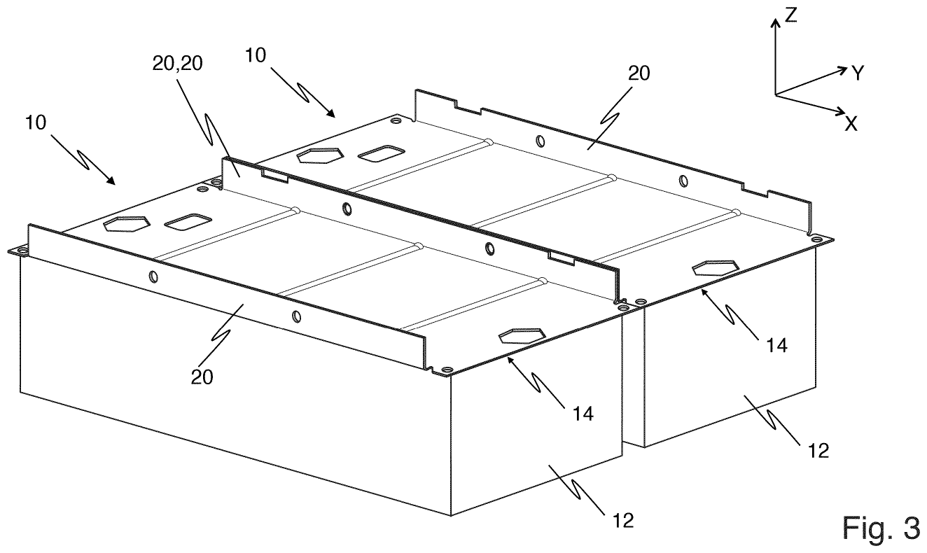

FIG. 3 shows two battery module arrangements 10 which are shown in FIGS. 1 and 2 and which are arranged one next to the other along the transverse direction Y and are connected to one another in a frictionally engaging fashion by means of tabs 20 which bear on one another. In order to connect the battery module arrangements 10 in a frictionally engaging fashion, the tabs 20 which bear one on the other are connected to one another by means of semi-tubular punch rivets (not shown here). In this context, the two drilled through-holes 26 of the tabs 20 which are connected to one another are oriented relative to one another.

Insofar as applicable, all the individual features which are elucidated in the exemplary embodiments can be combined and/or interchanged with one another without departing from the scope of the invention.

### LIST OF REFERENCE NUMBERS

10 battery module arrangement
12 battery module
14 lid
16 battery module housing
18 cover section
20 tabs
22 cutout
24 first drilled through-hole
26 second drilled through-hole
28 recess

1: A lid for a battery module, comprising a cover section for pole-side attachment of the lid to the battery module, and tabs which are provided at opposite ends of the cover section, arranged inclined relative to the cover section and, in a state in which the lid is configured to be installed on the battery module, extend from the cover section in a direction pointing away from the battery module.

2: The lid according to claim 1, wherein the tabs each form a flange, in particular for attaching the cover to a carrier structure of at least one of: a battery and a further cover of a battery module.

3: The lid according to claim 1, wherein the tabs have at least one connecting element which is complementary to a mounting tool, wherein the at least one connecting element is configured to mechanically connect the lid to the mounting tool in a detachable fashion.

4: The lid according to claim 3, wherein the at least one connecting element is a through-opening which passes through the tabs.

5: The lid according to claim 1, wherein the tabs extend along a longitudinal side of at least one of: the lid and the battery module.

6: The lid according to claim 1, wherein in the state in which the lid is mounted on the battery module the tabs project beyond the battery module along a transverse direction of at least one of: the lid and the battery module on at least one side.

7: The lid according to claim 1, wherein in the state in which it is mounted on the battery module, a width of the lid along a transverse direction (Y) of at least one of: the lid and the battery module is greater than or equal to a width of the battery module.

8: The lid according to claim 1, wherein the tabs are inclined substantially about 90° relative to the cover section.

9: The lid according to claim 1, wherein said lid has a U-shaped profile in cross section, wherein the cover section forms a web, and the tabs adjoining the web form limbs of the U-shaped profile, and wherein in the state in which the lid is mounted on the battery module the outer side of the web of the U-shaped profile at least one of: bears against the battery module and lies opposite the battery module.

10: The lid according to claim 1, wherein the cover section comprises at least one positively engaging element which is complementary to a structure of the battery module, in particular in the form of a cutout, for at least one of: positioning the lid relative to the battery module and connecting the lid to the battery module in a positively engaging fashion.

11: The lid according to claim 1, wherein the cover section has two cutouts for poles of the battery module, wherein in the mounted state on the battery module the poles are at least one of: arranged in the cutouts and project through the cutouts and are, in particular, in positively engagement therewith.

12: A battery module arrangement, in particular for an electric vehicle, having at least one battery module and one lid, wherein the lid is configured to be attached on a pole side to the battery module.

13: A battery, comprising at least two battery module arrangements, wherein at least one of the at least two battery module arrangements comprise at least one battery module and one lid, wherein the lid is configured to be attached on a pole side to the battery module, wherein the at least two battery module arrangements are connected to one another via tabs, lying opposite one another, of the lids of the battery module arrangements.

14: The battery according to claim 13, wherein the tabs, lying opposite one another, of the respective lids bear one on the other and are connected to one another in at least one of: a frictionally engaging and a materially joined fashion, in particular by means of semi-tubular punch rivets.

15: The lid according to claim 4, wherein the through-opening is at least one of: a drilled through-hole, an elongate hole, a punched-out portion, and a polygonally formed opening.

16: The lid according to claim 5, wherein the tabs extend along at least 50% of the longitudinal side of at least one of: the lid and the battery module.

17: The lid according to claim 5, wherein the tabs extend along 90% of the longitudinal side of at least one of: the lid and the battery module.

18: The lid according to claim 6, wherein the tabs have a flange for connecting to at least one of: a battery component and a further flange of an adjacent battery module, wherein the flange is formed bent outward with respect to the plane of the tab.

19: The lid according to claim 1, wherein the battery module is configured to be used in an electric vehicle.

20: The battery according to claim 13, wherein the battery is configured to be used in an electric vehicle.
